(19) United States
(12) Patent Application Publication
(10) Pub. No.: US 2007/0130088 A1
(43) Pub. Date: Jun. 7, 2007

(54) System and method for facilitating value-adding businesses

(76) Inventors: Peter Kern, Westminster, CO (US); Scott Fowle, Louisville, CO (US); Mike Doe, Thornton, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/342,715

(22) Filed: Jan. 30, 2006

Related U.S. Application Data
(60) Provisional application No. 60/742,475, filed on Dec. 5, 2005.

(51) Int. Cl. G06F 17/00; G06G 7/00

(52) U.S. Cl. 705/400

(57) ABSTRACT

A system and method for assisting a plurality of separate businesses is described. In one variation, the method includes establishing a plurality of customized Internet home pages corresponding to the plurality of separate value-adding businesses, and receiving a purchase order via at least one of the plurality of customized Internet home pages. Based on the purchase order, information is sent to a value-adding business and a request for unfinished goods is sent to at least one supplier of unfinished goods. The supplier provides the unfinished goods to the value-adding business to enable the business to alter the unfinished goods in accordance with the purchase order information.

### PRIORITY

Priority is claimed to provisional application No. 60/742,475 filed on Dec. 5, 2005, entitled Business System and Method, which is incorporated herein by reference.

### FIELD OF THE INVENTION

The present invention relates to business systems and methods. In particular, but not by way of limitation, the present invention relates to systems and methods for providing value-added operations.

### BACKGROUND OF THE INVENTION

In many instances, persons or established business posses the skill and knowledge to perform particular value-added operations that render ordinary goods more desirable by altering, adding to or improving the goods. For example, there are many businesses that sell embroidery, printing, engraving or other types of services that perform very well when providing these value-adding type of operations.

Operating a viable business, however, often requires much more than simply providing value-adding services. In particular, there are several “non-value-added” operations such as marketing, sales, purchasing of materials, logistics, finance and information services that many businesses do not have either the resources, skills and/or the desire to become engaged in.

In many instances, for example, the business proprietor may have exceptional skills when rendering particular services (e.g., printing services), but may have no experience, nor any desire, to become experienced in sales, marketing, logistics and finances. In many instances, however, a business simply can not profitably operate without having these non-value-added operations in place.

Accordingly, a system and method are needed to take care of these non-value-added added operations and to provide other new and innovative features.

### SUMMARY OF THE INVENTION

In some embodiments, the invention may be characterized as a method for enhancing business performance for a plurality of separate businesses that add value to goods by finishing them. In these embodiments, the method includes establishing a customized internet home page for each of the plurality of separate businesses, and then receiving, from an end customer, a purchase order including a description and/or requirements for the finished goods. The description and/or requirements for the finished goods are then sent to a selected one of the plurality businesses and a corresponding request for unfinished goods is sent to at least one potential supplier of unfinished goods. The supplier of unfinished goods then supplies the unfinished goods to the selected business so as to enable the selected business to incorporate the description and/or requirements with the unfinished goods.

In variations, the method includes assisting the plurality of separate businesses with the acquisition of unfinished goods from potential suppliers, and in yet other variations, the method includes receiving inquiries from the end customers and directing the end customers to one or more of the businesses.

In another embodiment, the invention may be characterized as a system for assisting businesses. The system in this embodiment includes a website server configured to enable each of a plurality of distinct businesses to generate a customized web page. In this embodiment, the website server also hosts the customized web pages, and receives purchase orders via the customized web pages that include respective orders for particular services in connection with particular goods. The website server is also configured to send information about the particular services to the businesses and information about the particular goods to at least one supplier of the goods. An accounting database in this embodiment receives and stores transaction information so as to enable an entity controlling the website server and the accounting database to retrieve and manage information about each of the purchase orders.

In yet another embodiment, the invention may be characterized as a business management server, which includes a module configured to enable each of a plurality of separate businesses to customize their own home page and an ecommerce module configured to provide each of the customized web pages as an interface for end customers to order finished goods from each of the separate businesses. A supplier database in this embodiment provides information about available suppliers of goods and enables requests for particular goods to be routed to the appropriate suppliers. In addition, an accounting database is configured to store information relative to each order for finished goods so as to enable fees to be collected based upon one or more aspects of the orders.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of one implementation of the present invention;

FIG. 2 is a block diagram of an exemplary business solution system;

FIG. 3 is a flowchart depicting an exemplary business method;

FIG. 4 illustrates an exemplary user interface; and

FIG. 5 is a block diagram of one embodiment of a value-adding business depicted in FIG. 1.

### DETAILED DESCRIPTION

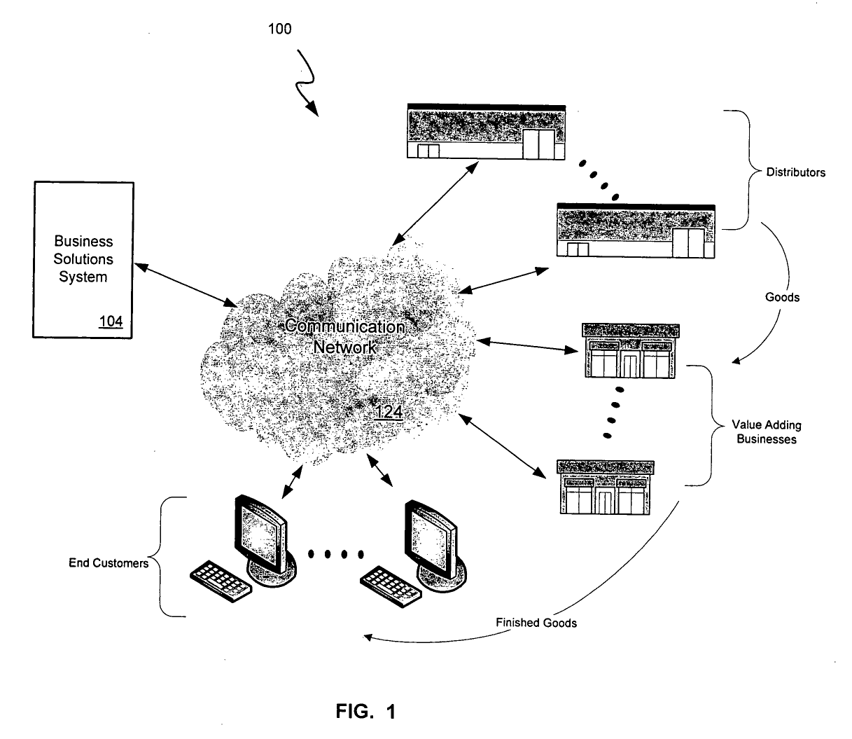

Referring now to the drawings, FIG. 1 depicts an exemplary environment in which several embodiments of the inventive business model may be employed. As shown in FIG. 1, a business solutions system 104 is in communication with distributors, value-adding businesses and end customers. The value-adding businesses in several embodiments are businesses that add value in one or more ways to goods. For example, the value-adding businesses may be screen printing businesses, embroidery businesses, engraving businesses, carving businesses, printing businesses, painting businesses or any other business that adds value to goods.

The distributors depicted in FIG. 1 are providers of goods, which may include, without limitation, clothing, wood, ceramics, paper, fabrics, metal as well as any other goods that may be operated on by the value-adding businesses. The distributors may create and sell the goods or simply buy and sell the goods. In many instances the distributors are wholesale distributors, but this is certainly not required.

The end customers depicted in FIG. 1 are people or business entities that desire finished goods from the value-adding businesses. As depicted in FIG. 1, the end customers have access to network enabled devices (e.g., computers, PDAs, telephone handsets), which enable the end users to communicate via the network 124 (e.g., the Internet) to the business solution system 104.

The business solution system 104 in the exemplary embodiment enables several aspects of the inventive business model. In particular, the business solution system 104 in several embodiments provides several “non-value-added” operations for the value-adding adding businesses such as marketing, sales, purchasing of materials, logistics, finance, MIS, etc. In return for providing these non-value-added operations, a controller of the business solution system 104 realizes revenue based upon a subscription-based and/or transaction-based fee structure. It should be recognized that the business solution system 104 is depicted in FIG. 1 as a single component merely for purposes of clarity, and that the business solution system 104 may be realized by a collection of discrete components that may be distributed over one or more physical locations.

In many embodiments, the business solution system 104 provides the value-adding businesses with a combination of one or more of the following operations:
A wizard to conveniently setup and customize a home page, billing schemes/rules, tax rates, financial services (means for payment, such as credit cards, PayPal, etc.), accounts with shipping companies and material suppliers.
Marketing operations including a search-engine-optimized home page; a feeder site to direct traffic to the businesses; customer contacts; means for advertisement as well as means for communication.
Sales operations including a customizable ecommerce storefront, allowing the businesses to present a wide variety of goods and services in a variety of languages. End-customers in many embodiments are able to order goods/services based on customized pricing scheme.
Purchasing of materials: as end-customers order through the ecommerce storefront, in some variations the system automatically places an order with the distributor(s) for the needed materials
Logistic services: through a integration with one or more shipping companies, the businesses are able track the shipment of goods from the distributor(s). Furthermore, it allows the businesses to use the shipping services for shipments of its finished (value-added goods) to the end-customer (incl. providing tracking numbers on the web).
Financial services: the system in several embodiments automatically takes care of collecting money from the end-customer, paying the distributors(s), creating invoices, generating reports for taxes, etc.
Production order requirements: in some variations the system provides specific production order requirements to each value-adding business. The production order requirements include information, which assists the value-adding businesses to effectuate the finishing of unfinished goods. In the context of a value-adding business that performs embroidery services, for example, the production order requirements. in one embodiment, include frame definition (e.g., the size and shape of the embroidery frame that should be utilized), statistics (e.g., a specific location for design placement relative to a portion of the unfinished good (e.g., relative to collar of a shirt) and design characteristics (e.g., color and type of thread to be utilized).
MIS: in many implementations the system hosts storage and processing of a wide variety of data, such as customer/distributor orders, order status, and provides data backup for customer.
Production scheduling: the system in several variations schedules the next job in order of priority (including an expedite option), and line up the materials with the order.
Online help and customer service: an online assistance organization in many embodiments is provided as well as an email delivery system for confirming receipt of order and receipt of payment.
In some variations, the system also enhances marketing for the end customers by coordinating mass mailing of marketing materials (e.g., via email or standard mail).

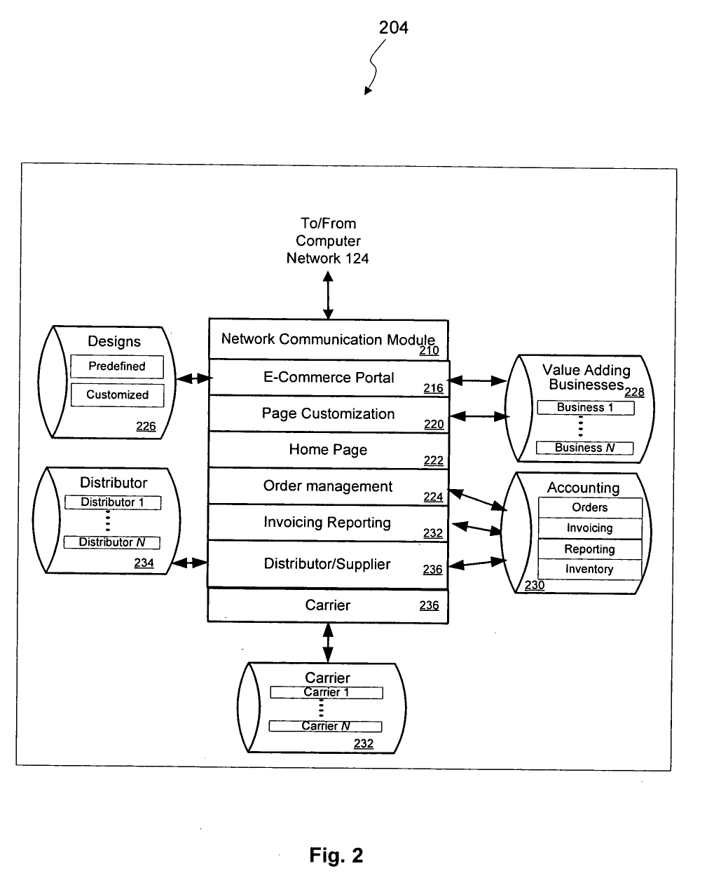

Referring next to FIG. 2, shown is an exemplary embodiment of a business solution system 204, which may be employed as the business solution system 104 depicted in FIG. 1. As depicted in FIG. 2, the system 204 includes a network communication module 210, an ecommerce portal 216, a page customization module 220, a home page module 222, an order management module 224, an invoicing and reporting module 232 a distributor module 236 and a carrier module 236. In several embodiments these modules are realized by software executed by one or more processors, but this is not required, and in other variations the modules may be realized by hardware or a combination of hardware and software. It should be recognized that the modules are shown as separate modules merely to depict the various functional aspects of the system 204 and that those of ordinary skill, having benefit of this disclosure, will appreciate that some of the modules may be combined together. It should also be recognized that the modules certainly need not be located in one physical location and that a controller of the system 204 may outsource some of the functions to third parties. Moreover, this embodiment is merely exemplary and in other embodiments one or more of the modules are omitted from the system 204.

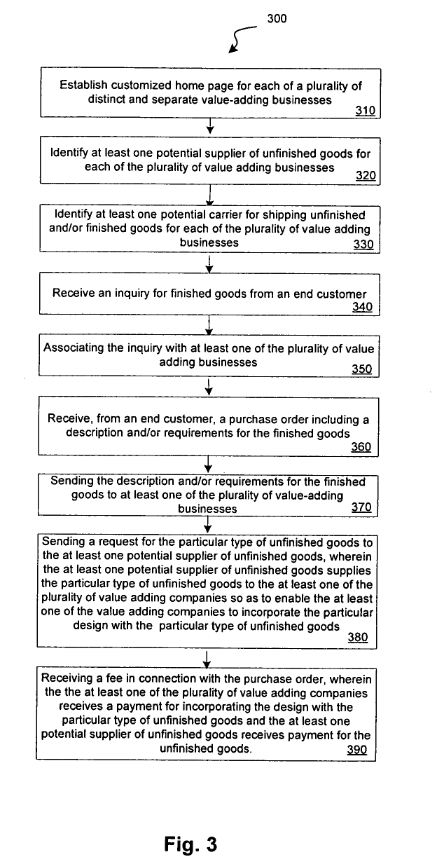

Also depicted in FIG. 2 are a design database 226, a value-adding businesses database 228, an accounting database 230, a carrier database 232 and a distributor database 230. As shown in FIG. 3, the design database 226 includes both predefined and customized designs that are selectable by the end customers when ordering finished goods. The customized designs include designs customized by one or more of the businesses, which are organized so as to be retrievable by an end user when accessing a particular business' home page via the ecommerce portal 216.

In this embodiment, the value-adding companies database 228 includes information about each of the businesses including data defining a customized home page for each of the businesses, products and services offered by the businesses and associated pricing established by each of the businesses.

The accounting database 230 in the exemplary embodiment includes information about each order placed by end customers, information to prepare invoices, information enabling reports to be generated (e.g., for tax purposes) and inventory information.

The carrier database 232 includes information (e.g., pricing) about carriers that are available to ship unfinished goods from distributors to the value-adding companies and finished goods from the value-adding companies to the end customers. Similarly, the distributor database 234 in this embodiment includes information about each of the distributors, the goods provided by each distributor and the pricing of the goods.

While referring to FIG. 2, simultaneous reference will be made to FIG. 3, which is a flowchart 300 depicting an exemplary business method, which may be carried out in connection with the systems 104, 204 depicted in FIGS. 1 and 2. Although the method depicted in FIG. 3 is described with reference to FIG. 1 and/or FIG. 2, it should be recognized that the method is certainly not limited to the specific embodiment depicted in FIGS. 1 and 2.

As shown in this embodiment, each business is able to create a customized home page using the page customization module 220 (Block 310). For example, each business is able to establish not only the look and feel of their home page but also billing schemes/rules, tax rates, financial services including payment arrangements (e.g., credit cards, PayPal, etc.). In addition, each value-adding business is able to identify any accounts that they have with shipping companies and material suppliers.

As shown in FIGS. 2 and 3, the distributor module 236 in connection with the distributor database 234 assist the value-adding businesses with identifying potential suppliers of goods (Block 320), and in many instances these components enable the value-adding businesses to obtain better pricing from the distributors. Similarly, the carrier module 236 in connection with the carrier database 232 enable the value-adding businesses to identify potential carriers of both unfinished and finished goods.

As depicted in FIG. 3, in accordance with the exemplary business method, an inquiry from an end customer is received (e.g., via home page 222 of the system 204) (Block 340), and in response, one or more links to home pages of one or more of the value-added businesses are provided to the end customer (Block 350). The end customer is then able to generate, using a customized homepage for one of the value-adding businesses, a purchase order, which includes a description and/or requirements for finished goods (Block 360).

In accordance with several embodiments, the ecommerce portal 216 enables the end customer to select either a predefined design from the design database 226 or submit their own customized design to be used in connection with goods also selected by the end user. As depicted in FIG. 2, the order management module 224 processes the order from the end user and stores information for the order in the accounting database 230.

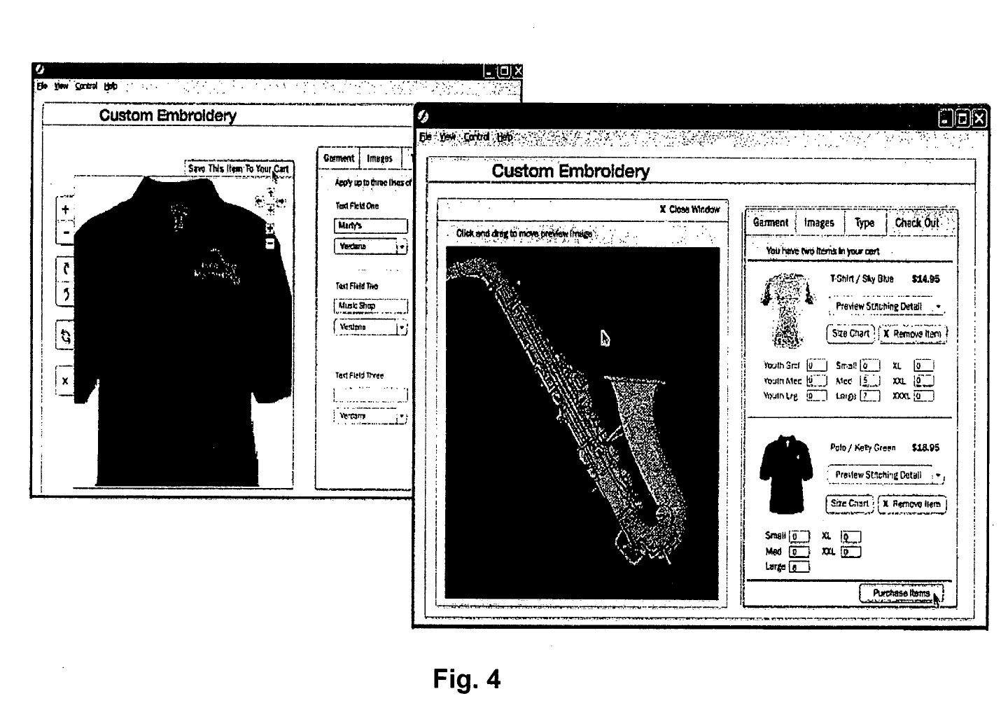

Referring briefly to FIG. 4, shown is a an exemplary user interface such as may by utilized by a value-adding embroidery business. In the embodiment depicted in FIG. 2, the ecommerce portal 216 generates the user interface in connection with previously generated data (e.g., from the value-adding business database 228) that defines the interface. As shown, the exemplary interface lets an end customer select a particular design, and then view a depiction of the finished goods embodying the particular design. In the specific example, an end customer has selected a saxophone design, which is shown embodied as part of a shirt. As depicted in FIG. 4, the exemplary interface enables the end customer to select a type, color, size and quantity of the particular good used in connection with the design.

Advantageously, in several variations the user interface provides a realistic rendering of the goods as adapted with the user-selected design. In this way, the end customer is able to make informed buying decisions and is much less likely to be surprised when they receive the finished product.

Referring again to FIG. 3, once the end customer has completed their purchase order, the description and/or requirements are sent to the value-adding business (Block 370). In many embodiments, the system 204 sends the description and/or requirements to the value-adding business via email, but this is certainly not required, and in other embodiments, the description and/or requirements may be pulled from the system 204 by the value-adding business.

In addition, a request for a quantity of unfinished goods (based upon the description and/or requirements in the purchase order) is sent to one or more of the distributors (Block 380). The request in many embodiments includes information about the value-adding business that is to receive the goods as well as information about the carrier preferred/required by the value-adding business. As a consequence the value-adding business receives both the description and/or requirements from the 204 and the corresponding goods from one or more of the distributors without having to manage marketing, sales, or logistical operations.

Once the unfinished goods are received, the value-adding business adapts the unfinished goods in accordance with the description and/or requirements to create finished goods, which are then sent to the end customer. Advantageously, the value-adding business receives payment via the system 204, and information associated with each transaction is stored by the system 204 in the accounting database 230. In this way, the value-adding business is relieved of many of the onerous and/or time consuming operations associated with tracking receivables and accounting.

In accordance with several embodiments, a controller of the system 104, 204 receives a fee in connection with the purchase order. As a consequence, the value-adding businesses receive many non-value-adding operations from the system 104, 204 and a controller of the system receives a fee in return. In some variations, the system 104, 204 offers varying subscription levels to each of the value-adding businesses and receives either one-time or ongoing subscription revenues instead of, or in addition to, the transaction based fees.

The different subscription levels may offer varying levels of service relative to one or more of the operations provided by the system 104, 204 including, for example, different levels of marketing, accounting and page customization.

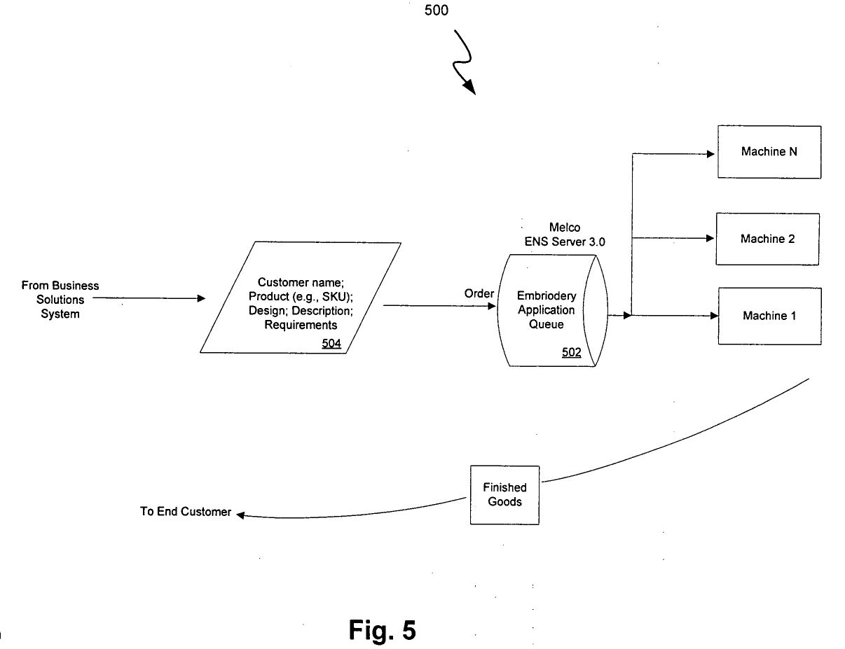

Referring next to FIG. 5, depicted is a block diagram of one embodiment of a value-adding business depicted in FIG. 1. As shown, in this embodiment the value adding business 500 includes a server 502 that is coupled to N (e.g., one or more) machines and is configured to receive a data file 504, which includes information for altering unfinished goods with the N machines.

The N machines in some embodiments are embroidery machines, in other embodiments the N machines are digitals printers, and in yet other embodiments the N machines are screen printing machines. In other variations it is contemplated that the N machines may be any other type of machine that is capable of receiving data and finishing goods in accordance with the data.

The server 502 in one embodiment is a general purpose computer that is adapted with software to operate as a server for receiving data files (e.g., the data file 504), queuing the data files and sending corresponding data to each of the N machines, which in general, informs the N machines what to do and how to do it.

In many embodiments for example, the data file 504 includes information defining both design and production order requirements, and may be organized in a variety of ways including dst, exp and other file organization schemes. The design information includes data that identifies the specific expression of an idea or concept (e.g., textual or graphical ideas/concepts), and the production order requirements include data that defines how to create a physical embodiment of the design.

In the context of embroidery production order requirements, for example, (i.e., where the N machines include embroidery machines), in one embodiment, the data file includes information that defines the type (e.g., square, circular, triangular, etc.) and size of the embroidery frame to be utilized, statistics that include location(s) on the unfinished product where the design is to be implemented and design characteristics (e.g., color and type of thread) to utilize.

In operation, the server 502 is configured to receive the data file 504 and place the data file 504 in a queue among of other data files that are awaiting to be processed. In connection with each received data file, the server 502 sends data to one or more of the N machines that enables the N machines to carry out production order requirements for each corresponding design. In the embodiments where the data file 504 includes production order requirements, the server 502 relays the productions order requirements to each of the N machines, and in embodiments where the data file 504 does not include production requirements, production requirements are added at the server 502 and sent to each of the N machines. Additional details related to effectuating operation of multiple stitching machines in accordance with design and requirements data is found in U.S. patent application Ser. No. 6,729,255, filed May 4, 2004, entitled: Synchronizing Independent Stitching Machines, which is incorporated herein by reference.

In some embodiments, the server 502 is made available to value-adding business that subscribe to a particular level of service provided by the business solutions system 100. In yet other variations, the server 502 is configured to be capable of being customized by each the value-adding businesses.

In conclusion, the present invention provides, among other things, a system and method, which provides a highly automated, worldwide accessible, hosted, computer/Internet based system for businesses that provides one or more operations that fall outside of the value-adding operations of the businesses. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A method for assisting a plurality of separate value-adding businesses comprising:
establishing a plurality of customized Internet home pages, each of the plurality of customized Internet home pages being established for a corresponding one of the plurality of separate value-adding businesses;
receiving, from an end customer, a purchase order via at least one of the plurality of customized Internet home pages, the purchase order including information for altering unfinished goods;
sending the information to at least one of the plurality of separate value-adding businesses; and
sending a request for unfinished goods to the at least one supplier of unfinished goods, wherein the at least one supplier of unfinished goods supplies the unfinished goods to the at least one of the plurality of value-adding companies so as to enable the at least one of the value-adding companies to alter the unfinished goods in accordance with the information.

2. The method of claim 1 including:
assisting at least a portion of the plurality separate value-adding businesses to acquire unfinished goods from potential suppliers of unfinished goods.

3. The method of claim 1 including:
providing marketing services to least a portion of the plurality of separate value-adding adding businesses.

4. The method of claim 3, wherein providing marketing services includes directing inquiries received at a centralized Internet home page from end customers to at least one of the plurality of customized Internet home pages.

5. The method of claim 3, wherein providing marketing services includes distributing marketing materials to potential end customers, wherein the marketing materials include advertising for the plurality of separate value-adding businesses, and wherein the distributing includes distributing via a medium selected from the group consisting of a physical medium and electronic medium.

6. The method of claim 1, wherein the information includes design information for altering the unfinished goods in accordance with a particular design.

7. The method of claim 1, wherein the information includes requirements information for altering the unfinished goods in accordance with particular requirements.

8. The method of claim 7, wherein the requirements information includes information selected from the group consisting of: embroidery-frame information, statistics information and design characteristics information.

9. The method of claim 1, wherein the information includes description information for altering the unfinished goods in accordance with a particular description.

10. The method of claim 1, wherein the information for altering unfinished goods includes information for altering unfinished goods including unfinished goods selected from the group consisting of: textiles, clothing, wood, ceramics, paper, fabrics, stone and metal.

11. The method of claim 1, wherein the value-adding businesses include value-adding businesses selected from the group consisting of screen printing businesses, embroidery businesses, engraving businesses, carving businesses, printing businesses, painting businesses and sculpture businesses.

12. The method of claim 1, including:
maintaining accounting information, the accounting information including information relative to a plurality of transactions, each of the transactions being characterized by a corresponding one of a plurality of purchase orders; and
enabling at least a portion of the value-adding businesses to access the accounting information.

13. A system for assisting businesses comprising:
a website server configured to:
enable each of a plurality of separate businesses to generate a corresponding one of a plurality of customized web pages;
host each of the plurality of customized web pages;
receive a plurality of purchase orders, each of the plurality of purchase orders being received via a corresponding one of the customized web pages and wherein each of the purchase orders includes an order for a particular service in connection with a particular type of good;
generate transaction information for each of the purchase orders so as to generate a plurality of transaction records, each of the transaction records including information about the corresponding particular service, the particular type of good and the corresponding one of the plurality of separate businesses;
sending the information about the particular type of good to at least one supplier so as to enable the at least one supplier to provide the particular type of good to the corresponding one of the plurality of separate businesses;
sending the information about the particular service to the corresponding one of the plurality of separate businesses so as to enable the corresponding one of the plurality of separate businesses to carry out the particular service in connection with the particular type of good.

14. The system of claim 13 including:
an accounting database in communication with the website server, wherein the accounting database is configured to:
receive and store the transaction information so as to enable an entity controlling the website server and the accounting database to retrieve information relative the plurality of purchase orders.

15. The system of claim 13 including an email server configured to send marketing information via email to potential end customers.

16. The system of claim 13, wherein the website server is configured to host a centralized Internet page configured to receive and direct inquiries from end customers to at least one of the plurality of customized Internet home pages.

17. The system of claim 13, wherein the corresponding particular service includes a service selected from the group consisting of: screen printing services, embroidery services, engraving services, carving services, printing services, painting services and sculpture services.

18. The system of claim 13, wherein the particular type of good includes a particular type of good selected from the group consisting of: textiles, clothing, wood, ceramics, paper, fabrics, stone and metal.

19. The system of claim 13, wherein the information about the particular service includes information selected from the group consisting of: design information, requirements information and description information.

20. The system of claim 19, wherein the requirements information includes information selected from the group consisting of: embroidery-frame information, statistics information and design characteristics information.

21. A business management server including:
a module configured to enable each of a plurality of separate businesses to generate a corresponding one of a plurality of customized web pages;
an ecommerce module configured to provide each of the plurality of customized web pages as an interface for end customers to order finished goods from each of the separate businesses;
a supplier database including information relative to at least one supplier of goods;
a supply request module configured to order particular goods from the at least one supplier in response to an order for particular finished goods from an end customer made via one of the customized web pages, wherein the order includes information so as to enable the at least one supplier to ship the particular goods to the business corresponding to the one of the customized web pages, wherein the business performs operations on the goods to generate the particular finished goods; and
an accounting database configured to store information relative to each order for finished goods.

22. The business management server of claim 20, wherein the ecommerce module is configured to host a centralized Internet page configured to receive and direct inquiries from end customers to at least one of the plurality of customized Internet home pages.

23. The business management server of claim 20, wherein the particular goods include goods selected from the group consisting of: textiles, clothing, wood, ceramics, paper, fabrics, stone and metal.

24. The business management server of claim 20, wherein the business performs operations including operations selected from the group consisting of: screen printing operations, embroidery operations, engraving operations, carving operations, printing operations, painting operations and sculpture operations.

25. The business management server of claim 20, wherein the an order for particular finished goods includes information selected from the group consisting of: design information, requirements information and description information.

26. The business management server of claim 25, wherein the requirements information includes information selected from the group consisting of: embroidery-frame information, statistics information and design characteristics information.
